(19) United States
(12) Patent Application Publication
(10) Pub. No.: US 2025/0042794 A1
(43) Pub. Date: Feb. 6, 2025

(54) WATER TREATMENT SYSTEM

(71) Applicant: FERMI RESEARCH ALLIANCE, LLC, Batavia, IL (US)

(72) Inventors: Charlie Cooper, Wheaton, IL (US); Slavica Grdanovska, North Aurora, IL (US)

(21) Appl. No.: 18/680,614

(22) Filed: May 31, 2024

Related U.S. Application Data
(60) Provisional application No. 63/530,219, filed on Aug. 1, 2023.

(51) Int. Cl. C02F 9/00; C02F 101/36

(52) U.S. Cl. CPC C02F 9/00; C02F 2101/36; C02F 2209/02; C02F 2209/06

(57) ABSTRACT

Methods and systems for removing PFAS from a water flow include inputting an input flow of water with a concentration of PFAS in the water, filtering the input flow of water to increase the concentration of PFAS in the water, purging the input flow of water with a concentration of PFAS in the water, increasing the pH of the input flow of water with a concentration of PFAS in the water, heating the input flow of water with a concentration of PFAS in the water, exposing the input flow of water to an electron beam thereby generating aqueous electrons to destroy at least some of the of PFAS in the water, and outputting an output flow of water with a PFAS concentration lower than the input flow of water.

### CROSS REFERENCE TO RELATED PATENT APPLICATIONS

This patent application claims the priority and benefit under 35 U.S.C. § 119 (e) of U.S. Provisional Patent Application Ser. No. 63/530,219 filed Aug. 1, 2023, entitled “WATER TREATMENT SYSTEM.” U.S. Provisional Patent Application Ser. No. 63/530,219 is herein incorporated by reference in its entirety.

### STATEMENT OF GOVERNMENT RIGHTS

The invention described in this patent application was made with Government support under the Fermi Research Alliance, LLC, Contract Number DE-AC02-07CH11359 awarded by the U.S. Department of Energy. The Government has certain rights in the invention.

### TECHNICAL FIELD

Embodiments are related to the field of water treatment. Embodiments are also related to particle accelerators. Embodiments are further related to the field of water treatment using particle accelerator devices. Embodiments are further related to removal of per- and polyfluoroalkyl substances in water. Embodiments are further related to systems and methods for destroying per- and polyfluoroalkyl substances in water with particle beams, such as electron beams.

### BACKGROUND

Per- and polyfluoroalkyl substances (PFAS) are commonly used, and long lasting chemicals. The chemical make-up of PFAS breaks down very slowly. Because of their widespread use and their persistence in the environment, the Environmental Protection Agency reports that many different kinds of PFAS have been detected in blood samples taken from both animals and people. Likewise, concerning levels of PFAS have been found in food, products, and are dispersed in the environment, particularly water supplies, the world over.

Exposure to some PFAS in, for example drinking water, or other environments have been linked with serious health effects in humans and animals. Because there are thousands of PFAS chemicals, and they are found in many different consumer, commercial, and industrial products it is exceedingly difficult to determine all the potential human health and environmental risks.

With this in mind, efforts are underway to better detect and measure PFAS in our air, water, soil, fish, and wildlife, determine the true exposure to PFAS, determine how harmful PFAS are to people and the environment, determine safe PFAS levels for people and animals, and determine how best to remove PFAS from drinking water.

There are currently numerous methods for removing PFAS from water. However, most such solutions are directed toward filtering techniques. For example, filters containing activated carbon or reverse osmosis membranes can be used to remove PFAS from water supplies. In the case of reverse osmosis, energy is required to push water through a porous membrane, which stops PFAS contaminants while allowing water to flow. Granular activated carbon filters strain water flow so that PFAS contaminants accumulate on the filter while water passes through.

While these systems are effective at removing PFAS from a specific water stream, they do not address the fundamental problem, the existence of the PFAS in the first place. After the water is filtered an effluent stream is left, which is highly concentrated with PFAS. Inevitably, this effluent makes its way back into water sources, ultimately exacerbating the problem.

Furthermore, all such water filtering systems require regular maintenance to work properly. If the filters are not carefully maintained they become ineffective at filtering PFAS, resulting in untreated water streams.

As such, there is a need in the art for methods and systems that destroy PFAS in water streams, as disclosed in the embodiments provided herein.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide a method, system, and apparatus for water treatment.

It is an aspect of the disclosed embodiments to provide methods and systems for improved water treatment using particle accelerators.

It is an aspect of the disclosed embodiments to provide methods and systems for improved water treatment using electron beams.

It is an aspect of the disclosed embodiments to provide methods and systems for destroying PFAS in water.

It is another aspect of the disclosed embodiments to provide methods and systems for destroying PFAS in water with electron beams.

Aspects of the disclosed embodiments will now be described in further detail. For example, in an embodiment a fluid treatment method comprises inputting an input flow of water with a concentration of PFAS in the water, exposing the flow of water to an electron beam thereby generating aqueous electrons, destroying some of the concentration of PFAS in the water, and outputting an output flow of water with a PFAS concentration lower than the input flow of water. In an embodiment, the fluid treatment method further comprises filtering the input flow of water with a filter in order to generate a clean fluid stream, and an effluent stream of water with a higher concentration of PFAS than the input flow of water, wherein exposing the flow of water comprises exposing the effluent stream of water to the electron beam. In an embodiment, the filtering comprises at least one of reverse osmosis, foam fractionation, ion exchange, granular activated carbon, and crystallization. In an embodiment, the fluid treatment method further comprises gas purging the input flow of water with a concentration of PFAS in the water. In an embodiment, the gas purging is done with nitrogen. In an embodiment, the gas purging is done with an inert gas. In an embodiment, the fluid treatment method further comprises increasing the pH of the input flow of water with a concentration of PFAS in the water. In an embodiment, the PH of the input flow of water is increased to a pH of 11-14. In an embodiment, increasing the pH of the input flow of water with a plurality of PFAS in the water comprises adding NaOH to the input flow of water with a concentration of PFAS. In an embodiment, the fluid treatment method further comprises decreasing the pH of the output the flow of water after exposing the water to the electron beam. In an embodiment, the fluid treatment method further comprises transferring heat from the water output after exposing the water to the electron beam, to the input flow of water with a concentration of PFAS, with a heat exchanger. In an embodiment, the fluid treatment method further comprises filtering the output flow of water with a PFAS concentration lower than the input flow of water, with an output filter.

In another embodiment, a fluid treatment method comprising inputting an input flow of water with a concentration of PFAS in the water, filtering the input flow of water to increase the concentration of PFAS in the water, purging the input flow of water with a concentration of PFAS in the water, increasing the pH of the input flow of water with a concentration of PFAS in the water, heating the input flow of water with a concentration of PFAS in the water, exposing the input flow of water to an electron beam thereby generating aqueous electrons to destroy at least some of the of PFAS in the water, and outputting an output flow of water with a PFAS concentration lower than the input flow of water. In an embodiment, the filtering comprises at least one of: reverse osmosis, foam fractionation, ion exchange, granular activated carbon, and crystallization. In an embodiment, the gas purging is done with one of: nitrogen or an inert gas. In an embodiment, heating the input flow of water with a concentration of PFAS in the water further comprises transferring heat from the output flow of water to the input flow of water with a concentration of PFAS, with a heat exchanger. In an embodiment, the fluid treatment method further comprises decreasing the pH of the output the flow of water after exposing the water to the electron beam.

In another embodiment, a fluid treatment system comprises an input for inputting an input flow of water with a concentration of PFAS in the water, a particle accelerator configured to generate an electron beam, a fluid channel configured to expose the input flow of water to the electron beam, thereby generating aqueous electrons which destroy some of the concentration of PFAS in the water, and an output for outputting an output flow of water with a PFAS concentration lower than the input flow of water. In another embodiment, the system further comprises at least one of a filter for filtering the input flow of water and a gas purging tank for gap purging the input flow of water with a concentration of PFAS in the water. In an embodiment the system further comprises a heat exchanger for transferring heat from the output flow of water to the input flow of water with a concentration of PFAS.

### BRIEF DESCRIPTION OF THE DRAWINGS

The accompanying figures, in which like reference numerals refer to identical or functionally similar elements throughout the separate views and which are incorporated in and form a part of the specification, further illustrate the embodiments and, together with the detailed description, serve to explain the embodiments disclosed herein.

FIG. 1 depicts a block diagram of a water treatment system for removing PFAS, in accordance with the disclosed embodiments;

FIG. 2 depicts the mechanism for removing PFAS in water with an electron beam, in accordance with the disclosed embodiments;

FIG. 3 depicts the mechanism of radiolysis in water, in accordance with the disclosed embodiments;

FIG. 4 depicts the distribution of aqueous electrons in water with a concentration of PFAS, in accordance with the disclosed embodiments;

FIG. 5 depicts the chemical mechanism for removing PFAS in water, in accordance with the disclosed embodiments;

FIG. 6 depicts a block diagram of steps associated with a method for treatment of water with a concentration of PFAS, in accordance with the disclosed embodiments;

FIG. 7 depicts a block diagram of steps associated with an enhanced method for treatment of water with a concentration of PFAS, in accordance with the disclosed embodiments;

FIG. 8 depicts a block diagram of steps associated with another enhanced method for treatment of water with a concentration of PFAS, in accordance with the disclosed embodiments;

FIG. 9 depicts a block diagram of steps associated with another enhanced method for treatment of water with a concentration of PFAS, in accordance with the disclosed embodiments;

FIG. 10 depicts a block diagram of steps associated with a method for treatment of water with a concentration of PFAS in a water treatment skid, in accordance with the disclosed embodiments;

FIG. 11 depicts a block diagram of steps associated with an enhanced method for treatment of water with a concentration of PFAS in a water treatment skid, in accordance with the disclosed embodiments;

FIG. 12 depicts a block diagram of steps associated with another enhanced method for treatment of water with a concentration of PFAS in a water treatment skid, in accordance with the disclosed embodiments;

FIG. 13 depicts a diagram of an accelerator assembly for treatment of water with a concentration of PFAS, in accordance with the disclosed embodiments;

FIG. 14 depicts a diagram showing aspects of an accelerator assembly for treatment of water with a concentration of PFAS, in accordance with the disclosed embodiments;

FIG. 15 depicts a chart of percentage of dose as a function of depth, in accordance with the disclosed embodiments; and

FIG. 16 depicts a charts of a percentage of PFAS removal as a function of does, in accordance with the disclosed embodiments;

FIG. 17 depicts a block diagram of a computer system which is implemented in accordance with the disclosed embodiments;

FIG. 18 depicts a graphical representation of a network of data-processing devices in which aspects of the present embodiments may be implemented;

FIG. 19 depicts a computer software system for directing the operation of the data-processing system depicted in FIG. 17, in accordance with an embodiment;

FIG. 20 depicts a perspective cut-away view of RF structures that can form elements of an electron accelerator that can be adapted for use in accordance with a preferred embodiment; and

FIG. 21 depicts a perspective cut-away view of a superconducting RF structure that can also form elements of an electron accelerator adapted for use in accordance with an embodiment. The figure indicates the operating principles of such an elliptical RF cavity;

### DETAILED DESCRIPTION

The particular values and configurations discussed in the following non-limiting examples can be varied, and are cited merely to illustrate one or more embodiments and are not intended to limit the scope thereof.

Example embodiments will now be described more fully hereinafter with reference to the accompanying drawings, in which illustrative embodiments are shown. The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. In addition, the term “based on” may be understood as not necessarily intended to convey an exclusive set of factors and may, instead, allow for existence of additional factors not necessarily expressly described, again, depending at least in part on context.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Some or all aspects of any embodiment disclosed herein may be incorporated with other embodiments without departing from the scope disclosed herein.

According to the methods and systems disclosed herein, electron beam accelerators can be used to destroy Per- and Polyfluorinated Substances (PFAS). Through a process called water radiolysis, accelerated electrons from the accelerator create species from the water that are only active when the beam is on (or microseconds thereafter). These species, especially aqueous electrons are good at destroying PFAS to elemental compositions. The ability to destroy PFAS is a distinct advantage to the electron beam process as compared to conventional water treatment technologies, like granular activated carbon, reverse osmosis, and ion exchange, which can only concentrate the PFAS that then still must be destroyed.

In certain embodiments, the electron beam process treatment can be run under specific conditions to maximize efficiency and breakdown PFAS. The electron beam process can be used as part of a larger water treatment system to more robustly and efficiently treat PFAS laden streams. Water treatment via electron beam (e-beam) exposure is effective at treating a wide range of contaminants. However, E-beam treatment, as disclosed herein, is capable of forming both highly oxidizing and highly reducing reactive species in water at the same time.

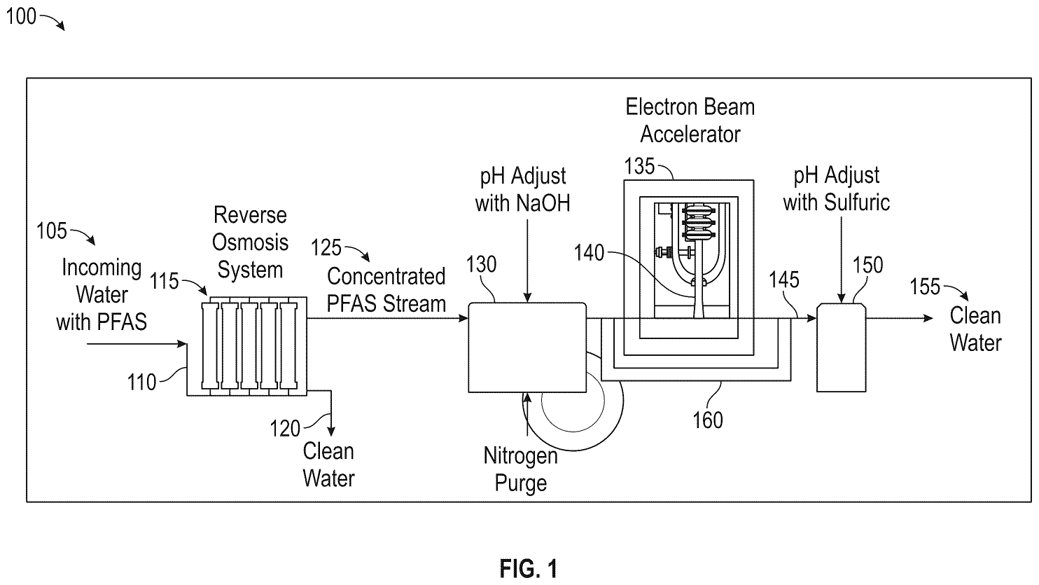

FIG. 1 illustrates a water treatment system 100 in accordance with the embodiments disclosed herein. The system 100 generally comprises an inlet 105 configured to transport a fluid flow 110 to a first filter 115. The fluid flow 110 can be a water flow containing a concentration of PFAS. The first filter 115 can comprise a reverse osmosis filter, a granular activated carbon filter, multiple such filters, or the like.

The first filter 115 can be used to remove PFAS from the water stream and create a highly concentrated PFAS effluent stream 125. This step is included because electron beam technology used to destroy the PFAS downstream is more efficient when applied to water streams with high concentrations of PFAS.

Clean water, free of PFAS, can be dispensed with first outlet 120. The concentrated PFAS effluent stream 125 can then be sent to a nitrogen purging assembly and pH adjuster 130. The concentrated PFAS effluent stream can be nitrogen purged and pH adjusted, with the nitrogen purging assembly and pH adjuster 130, before being provided to an accelerator assembly 135. The nitrogen purging assembly and pH adjuster 130 improves the PFAS destruction efficiency of the system 100. In an exemplary embodiment, the concentrated PFAS effluent stream 125 can be purged to 2 ppm DO and pH adjusted with NaOH to pH 11-12, although in other embodiments, other levels are possible.

The accelerator treatment assembly 135 can generally comprise a particle accelerator such as accelerator 2010. The accelerator 135 is used to generate an electron beam 140, which can be directed onto the concentrated PFAS effluent stream 125. The electron beam 140 effectively destroys the PFAS in the concentrated PFAS effluent stream 125, as further detailed herein.

The PFAS free water 145, exits the accelerator treatment assembly 135. Optimal PFAS destruction efficiency increases where concentrated PFAS effluent stream 125 is in the range of temperatures from 20 to 80° C. During the e-beam treatment the water temperature will rise 50-60° C. As breakdown efficiency increases with increasing temperature under the e-beam 140, the exit water 145 can be heat exchanged with heat exchanger 160, with the heat being applied to the concentrated PFAS effluent stream 125 to preheat it as much as possible; the limit being that the PFAS free water 145 exiting the accelerator treatment assembly 135 must be below the boiling point.

The PFAS free water 145 can then be subject to an additional pH adjustment with pH adjustment assembly 150. The pH adjustment assembly 150 can comprise a sulfuric acid treatment system, or other such pH adjuster. The pH adjusted clean water 155 is then dispensed at output 155.

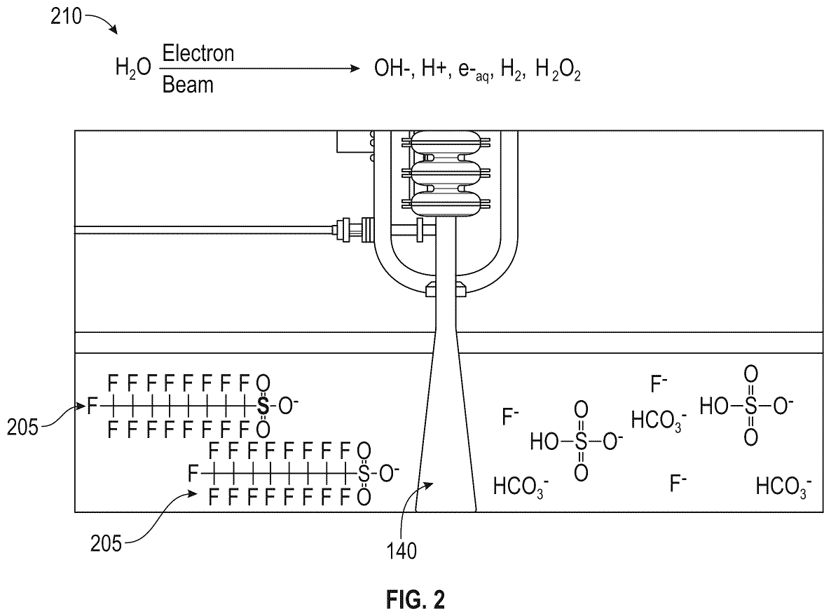

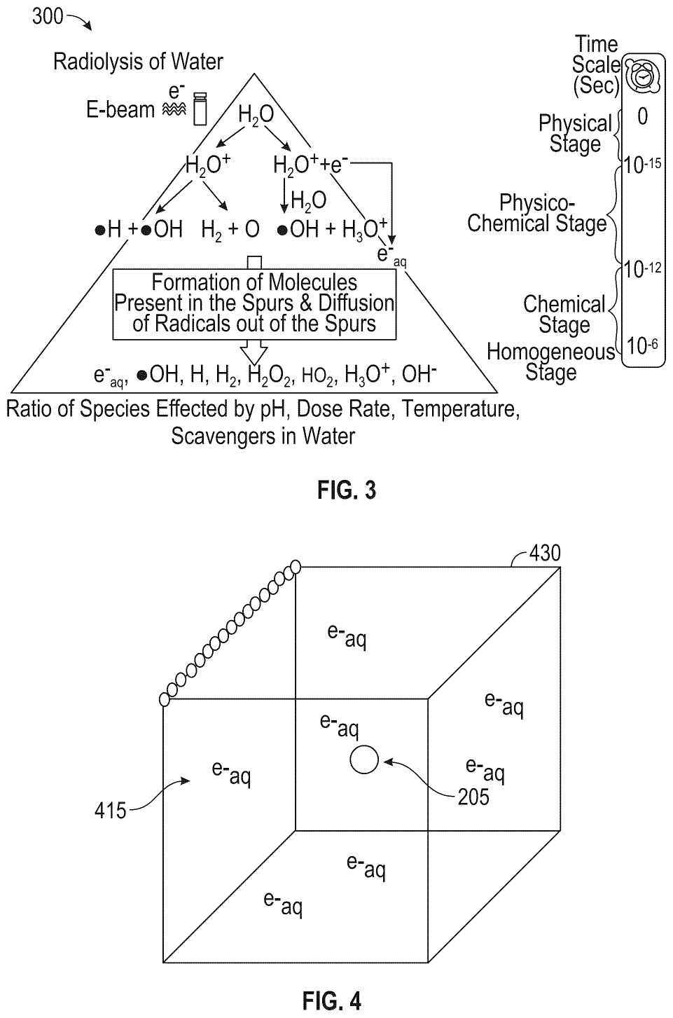

FIG. 2 illustrates the mechanism used in the disclosed embodiments, to destroy PFAS in water. As illustrated the electron beam 140 is incident on the water containing PFAS particles 205 (for example Perfluorooctane sulfonic acid, “PFOS,” or Perfluorooctanoic acid, “PFOA”). The electron beam can have an exemplary energy of nominally 10 MeV (although other energies are possible), with the electrons traveling at close to the speed of light. Most of the energy from the electron beam breaks down the water. This results in hydroxide, hydrogen, hydrogen ions, hydrogen peroxide, and most importantly, an aqueous electron as illustrated by equation 210. This breakdown is further illustrated in flow chart 300 of FIG. 3 illustrating the process of radiolysis in water.

The aqueous electron is key in breaking down the PFAS. FIG. 4 illustrates an exemplary volume of water 430. This diagram is meant to be exemplary only to illustrate that the aqueous electrons 415 can be disposed in the volume of water with a PFAS molecule 205. When the aqueous electron 415 interacts with the PFAS molecule 205, the functional group of the PFAS molecule results, followed by the unzipping of the C-F chain by hydrolysis, effectively destroying the PFAS molecule.

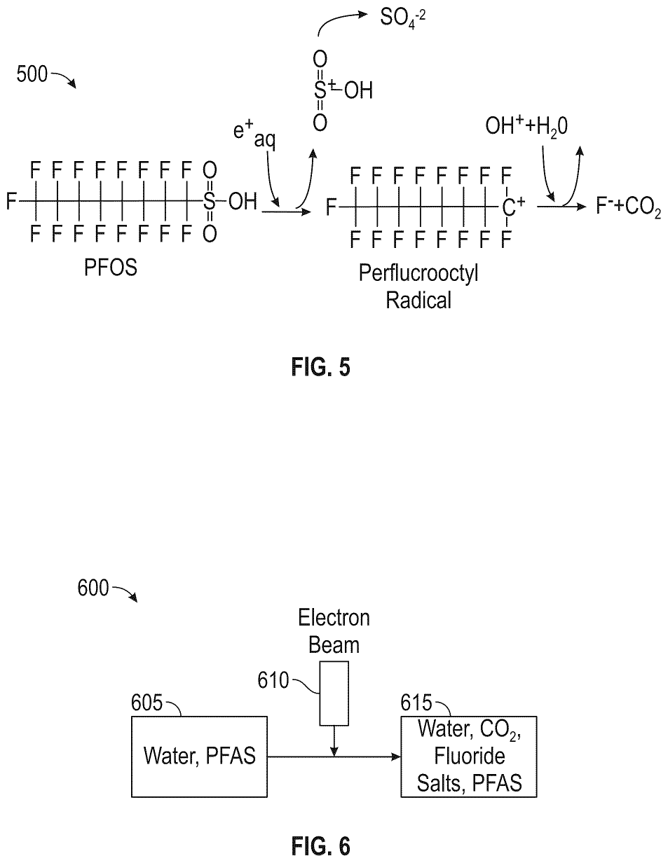

The aqueous electron(s) 415 thus, drive the degradation of PFAS because of their electronegativity. However, additional factors can further improve the efficiency of degradation. For example, increasing the temperature of the water with PFAS increases degradation efficiency increases. Likewise, as pH increases (e.g., from 7 to 13) break down efficiency of the PFAS in water increases. FIG. 5 illustrates an exemplary chemical process 500.

FIG. 6 illustrates another embodiment of a simple treatment method 600 for removing PFAS, in accordance with the disclosed embodiments. In this example, a flowing water stream 605, or moving water in a vessel, is exposed to an electron beam 610 which can destroy all or a portion of the PFAS in the water stream, changing it to fluoride salts and CO₂ in the water 615.

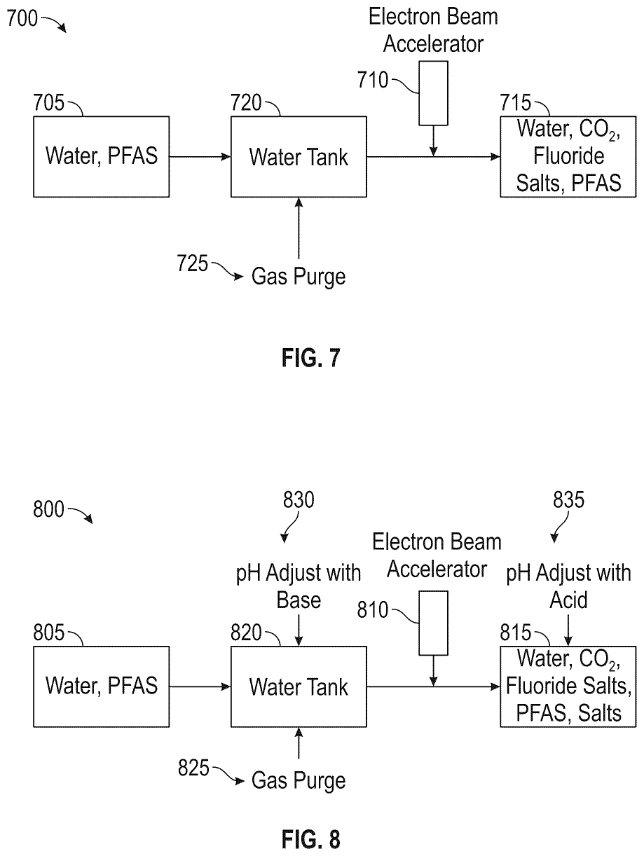

FIG. 7 illustrates another embodiment of an exemplary enhanced treatment method 700 for removing PFAS, in accordance with the disclosed embodiments. In this example, a flowing water stream 705, or moving water in a vessel, is exposed to an electron beam 710 which can destroy all or a portion of the PFAS, changing it to fluoride salts and CO₂ in the water 715. Before the water passes through the electron beam 710, it goes into a water tank 720 where some gas (e.g., nitrogen) is bubbled through the water as a gas purge 725. This removes dissolved oxygen which increases breakdown efficiency of PFAS and decreases the cost to break down the PFAS more than the additional cost of the associated purge step.

FIG. 8 illustrates another embodiment of an exemplary further enhanced treatment method 800 for removing PFAS, in accordance with the disclosed embodiments. In this example, a flowing water stream 805, or moving water in a vessel, is exposed to an electron beam 810 which can destroy all or a portion of the PFAS, changing it to fluoride salts and CO₂ in the water 815. Before the water passes through the electron beam it goes into a water tank 820 where some gas (e.g., nitrogen gas) is bubbled through the water at 825. This removes dissolved oxygen which increases breakdown efficiency of PFAS.

A base 830 (e.g., sodium hydroxide) can be added to the water tank 820 to increase the ratio of aqueous electrons in solution and increase the breakdown efficiency of the PFAS. Breakdown efficiency increases as the pH increases from 10 to 14. Optimum breakdown efficiency will happen at the highest pH values but the optimum cost efficiency or mass of PFAS destroyed per money spent will happen at a pH value that is determined by the cost of the base used. In most cases the optimum cost efficiency can be achieved at pH 13 and lower, while still ensuring the pH level is above 7. After electron beam treatment 810 the water can be pH adjusted down with an acid at 835 to whatever the local discharge values for pH are, typically near pH 10.

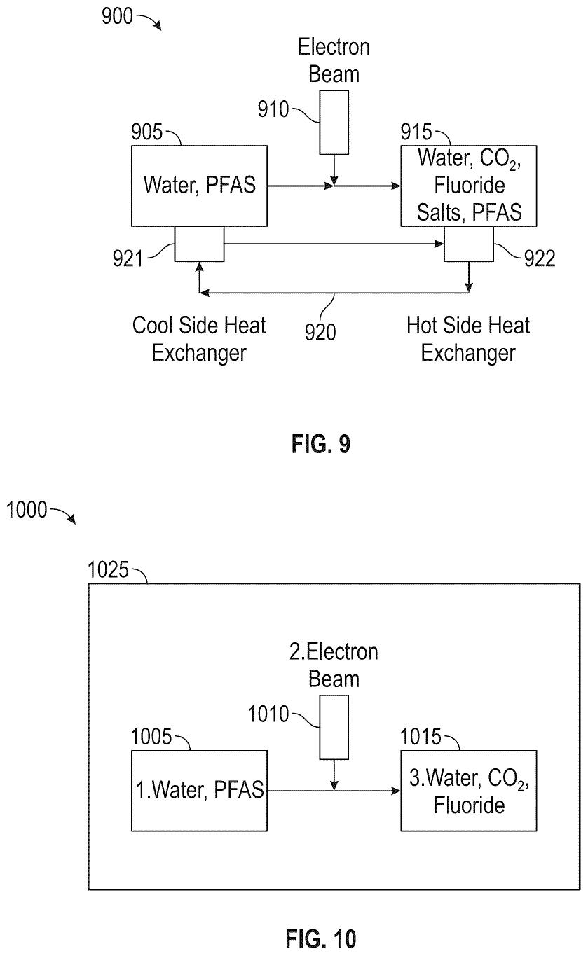

FIG. 9 illustrates another embodiment of an exemplary further enhanced treatment method 900 for removing PFAS, in accordance with the disclosed embodiments. In this example, a flowing water stream 905, or moving water in a vessel, is exposed to an electron beam 910 which can destroy all, or a portion of, the PFAS changing it to fluoride salts and CO₂ in the water 915. The electron beam 910 can heat the water up. The heat level will depend on the total dose of electrons delivered. The increase can be on the order of 10s of degrees Celsius.

A heat exchanger 920 can include a hot side heat exchanger 921 and a cool side heat exchanger 922. The heat exchanger 920 can be used to heat the incoming water with the already hot outgoing water. Heating the water before it reaches the electron beam 910 can boost the efficiency of the breakdown of PFAS. This method can be employed in conjunction with any of the other methods disclosed herein (for example, the methods illustrated in FIGS. 6-8).

FIG. 10 illustrates another embodiment of a simple treatment method 1000 for removing PFAS in a water treatment skid, in accordance with the disclosed embodiments. In this example, a water treatment skid 1025 can include a water stream 1005, which is exposed to an electron beam 1010. The electron beam 1010 can destroy all or a portion of the PFAS in the water stream, changing it to fluoride salts and CO₂ in the water 1015.

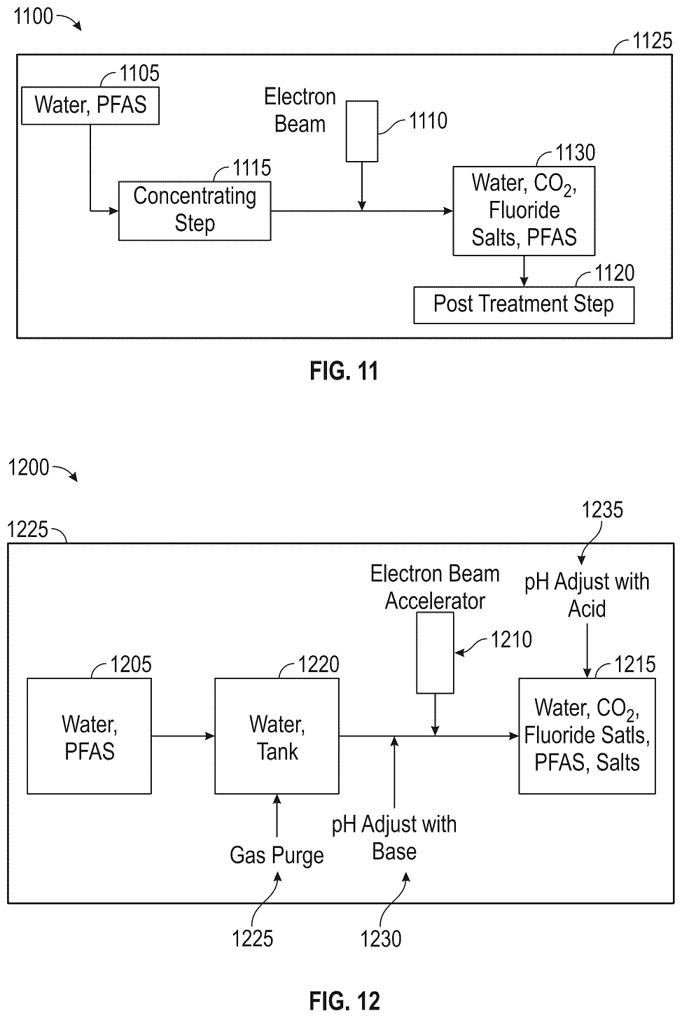

FIG. 11 illustrates another embodiment of a simple treatment method 1100 for removing PFAS in a water treatment skid 1125, in accordance with the disclosed embodiments. In this embodiment, the electron beam 1110 can be used to treat water 1105 in the water treatment skid 1125, in conjunction with a pre-concentration technique 1115, and or a post treatment step 1120.

In the range from parts per billion to 10s of parts per million of PFAS, little change in breakdown efficiency is realized, so in accordance with some embodiments it is preferable to treat concentrated streams, which is more energy and cost efficient.

The concentrating step 1115 can include any conventional water treatment technology. Some exemplary treatment methods can include foam fractionation, ion exchange, reverse osmosis, and crystallization. Using these techniques, the input stream of water with PFAS is filtered into a clean PFAS free stream and an effluent stream with a high concentration of PFAS. The concentrated stream is then treated with the electron beam to remove some, or all of the PFAS in the stream.

The post treatment step 1120 can include a water treatment technology. As the electron beam treatment 1110 is capable of destroying most or all of the PFAS, the post processing step 1120, applied after electron beam treatment, can be used like a final purification of the clean water 1130 to remove residual contaminants.

For example, in one embodiment, the post treatment step 1120 can comprise granular activated carbon (GAC) filtering. The GAC would remove any residual particulate matter and make the water palatable for commercial or residential use. Furthermore, providing the GAC after treatment would enhance the lifetime of the GAC filter because the concentrations of any remaining PFAS would be low.

FIG. 12 illustrates another embodiment of an enhanced treatment method 1200 for removing PFAS in a water treatment skid 1225, in accordance with the disclosed embodiments. In this example, a water stream 1205, is exposed to an electron beam 1210 which can destroy all or a portion of the PFAS, changing it to fluoride salts and CO₂ in the water 1215.

Before the water passes through the electron beam 1210 it goes into a water tank 1220 where some gas (e.g., nitrogen) is bubbled through the water as a gas purge 1225. Some additional cost and energy efficiencies may be had in the process flow shown in FIG. 12 because the gas purge that is used to remove dissolved oxygen is also used as a step to concentrate the PFAS in method similar to foam fractionation.

Furthermore, a base 1230 (e.g., sodium hydroxide) can be added to the water tank 1220 to increase the ratio of aqueous electrons in solution and increase the breakdown efficiency of the PFAS. Breakdown efficiency increases as the pH increases from 10 to 14. Optimum breakdown efficiency will happen at the highest pH values but the optimum cost efficiency or mass of PFAS destroyed per money spent will happen at a pH value that is determined by the cost of the base used. In most cases the optimum cost efficiency can be achieved at pH 13 and lower, while still ensuring the pH level is above 7. After electron beam treatment 1210 the water can be pH adjusted down with an acid at 1235 to whatever the local discharge values for pH are, typically near pH 10.

It should be understood that the various methods illustrated in FIG. 6-12 includes aspects, some, or all of which may be incorporated with other methods illustrated without departing from the scope disclosed herein.

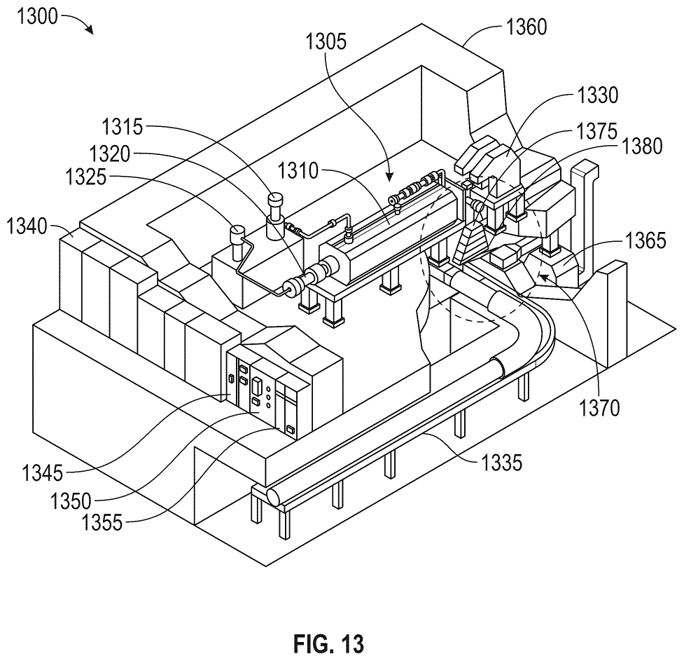

FIG. 13 illustrates an electron beam assembly 1300, for treating water in accordance with the disclosed embodiments. The assembly 1300 generally comprises an accelerator system 1305 comprising an accelerator tube 1310, klystron 1315, electron gun 1320, and electron gun controller 1325. An electron beam dispenser 1370 can include a bending magnet 1330 and scan magnet 1375, in conjunction with a scanning horn 1380, which can be used to direct and fan the electron beam onto the water flowing through pipe 1335.

The accelerator is powered with a pulsed power supply 1340. A system control 1345 can be used to control the power of the electron beam. A vacuum control 1350 and magnet power supply 1355 are also provided. The accelerator can be surrounded by radiation shielding 1360 and can include an ozone disposal unit 1365.

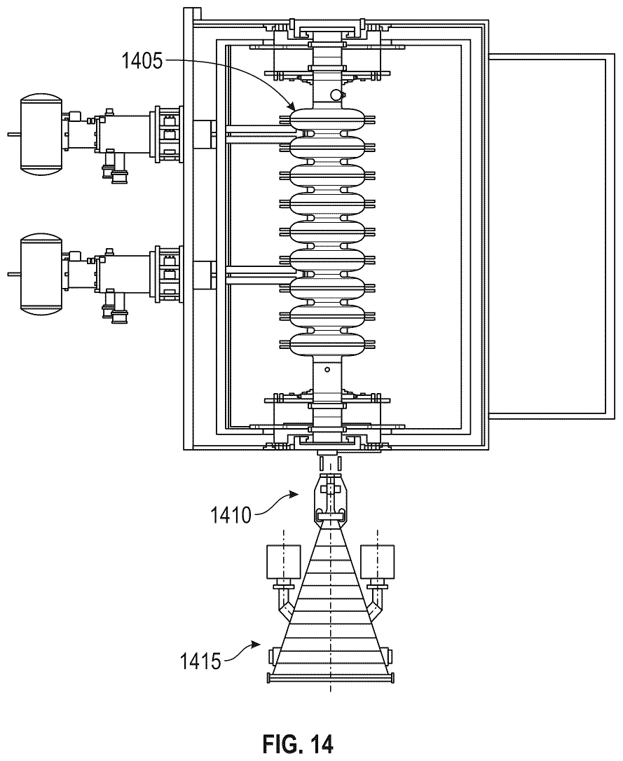

FIG. 14 illustrates aspects of the accelerator and electron beam dispenser in accordance with the disclosed embodiments. The electron beam is produced in the cavity 1405. As it exits, a sweep magnet 1410 can be used to sweep the magnet through extractor 1415.

The power of the electron beam can be selected and controlled using a controller, which can be embodied as software or hardware on a computer system. The power of the beam can be adjusted according to the flow rate of the water being treated as well as the according to the concentration of PFAS in the water and the desired level of PFAS destruction.

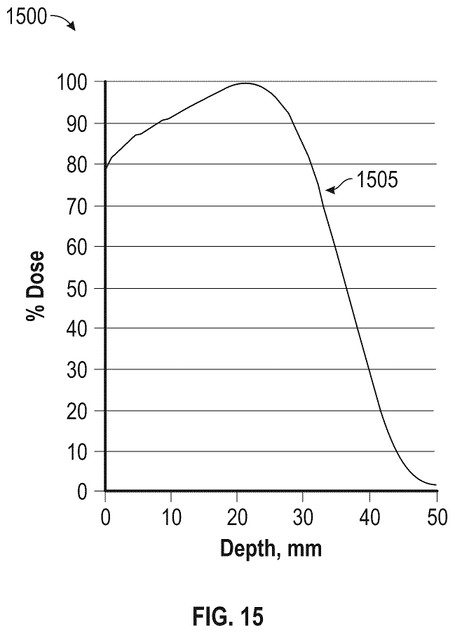

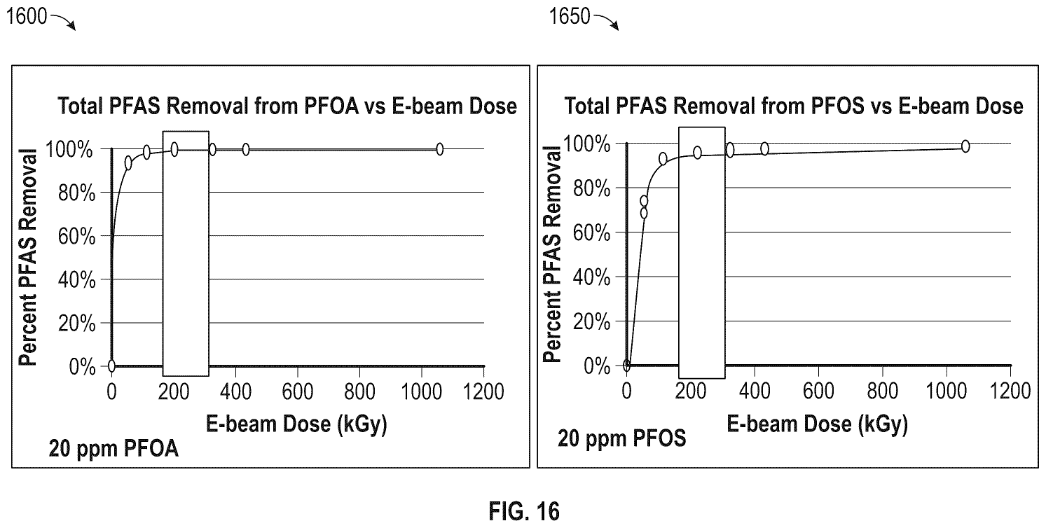

For example, FIG. 15 illustrates a chart 1500 showing the dose provided as a function of the depth of penetration. The curve 1505 can be used as a guide for selecting the electron beam parameters. Likewise, FIG. 16 illustrates chart 1600 showing the percent of PFOA (an exemplary PFAS) removal as a function of the E-Beam dose. Chart 1650 shows the percent of PFOS (another exemplary PFAS) removal as a function of the E-Beam dose.

The electron beam destruction of PFAS in water according to the systems and methods illustrated herein, can be applied in all, or most all, applications where the contaminated water is found. These include, but are not limited to, directly treating chemical manufacturing waste streams, localized spills, and large contaminated water systems like aquifers. The process can also be applied on a microgrid level to service government installations or small municipalities. The process can also be applied to destruction of PFAS in biosolids for even the largest municipalities. The process can be used to make potable water.

In accordance with the disclosed embodiments, an electron beam can be used for destruction of PFAS in water. This includes but is not limited to destruction of PFOA (perfluorooctanoic acid) and PFOS (perfluorooctane sulfonic acid), as well as PFOS homologs. According to the disclosed embodiments, complete destruction of PFOA and PFOS in water by the electron beam can be further supplemented by optimizing conditions to create aqueous electrons via water radiolysis.

For example, nitrogen purging of PFAS in water prior to electron beam treatment can remove the dissolved oxygen in the water which acts as scavenger of aqueous electrons. Use of other gasses (like exhaust gas) is also possible for purging of PFAS in water prior to electron beam treatment to remove the dissolved oxygen in the water. In certain embodiments, the nitrogen purging of PFAS in water prior to electron beam treatment to remove the dissolved oxygen in the water can be to a level of 2 ppm DO. Other levels are also possible although lower values does little to increase destruction efficiencies.

In another example, the pH of the PFAS laden water can be adjusted to the range of 10-13 with an additive like sodium hydroxide, or other bases, prior to electron beam treatment to increase the ratio of aqueous electrons produced via water radiolysis and increase the breakdown efficiency of PFAS.

In another example, heating the water increases the efficiency of breakdown of PFAS. In certain embodiments, the e-beam heats the water. To increase the efficiency of the breakdown, process the hot water leaving the e-beam treatment process can be heat exchanged with the cold water coming in to be treated.

Furthermore, decreases in dose rate increase degradation efficiency. The dose rate of the accelerator can be reduced, preferably to the range of 1 kGy/sec delivered to the water, although other dose rats can also be used.

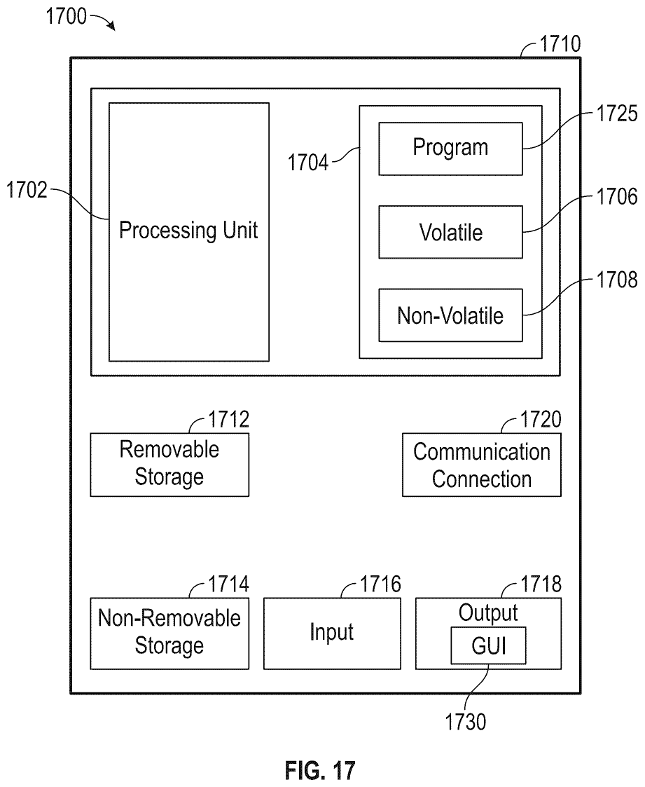

FIGS. 17-19 are provided as exemplary diagrams of data-processing environments in which embodiments of the present invention may be implemented. It should be appreciated that FIGS. 17-19 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

A block diagram of a computer system 1700 that executes programming for implementing parts of the methods and systems disclosed herein is shown in FIG. 17. A computing device in the form of a computer 1710 configured to interface with sensors, peripheral devices, and other elements disclosed herein may include one or more processing units 1702, memory 1704, removable storage 1712, and non-removable storage 1714. Memory 1704 may include volatile memory 1706 and non-volatile memory 1708. Computer 1710 may include or have access to a computing environment that includes a variety of transitory and non-transitory computer-readable media such as volatile memory 1706 and non-volatile memory 1708, removable storage 1712 and non-removable storage 1714. Computer storage includes, for example, random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage, or other magnetic storage devices, or any other medium capable of storing computer-readable instructions as well as data including image data.

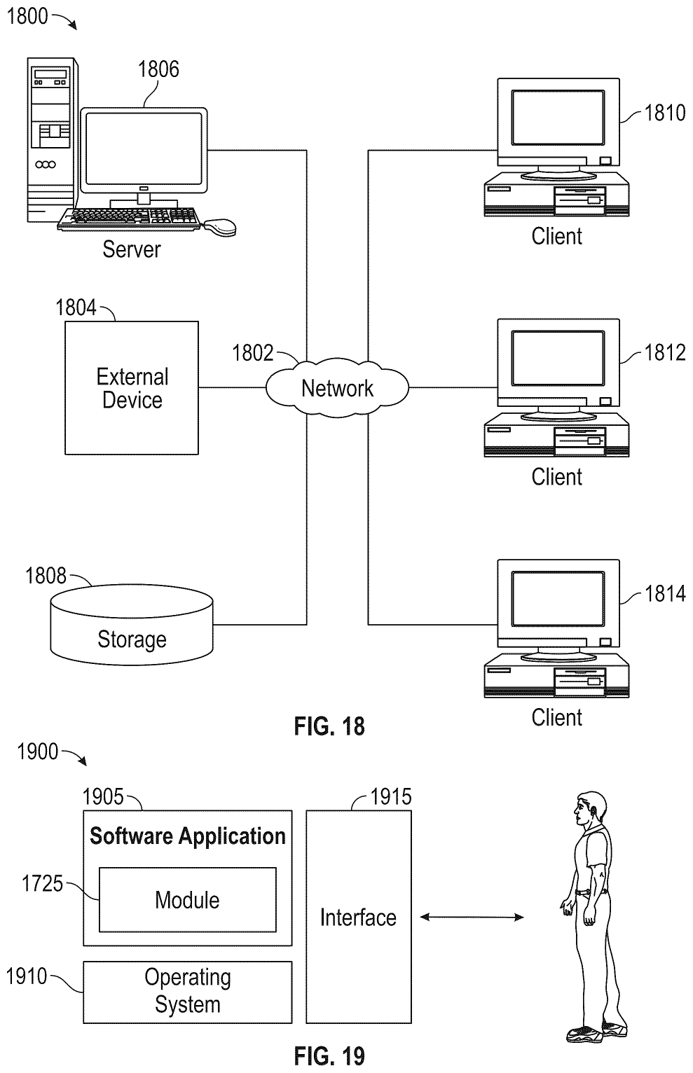

Computer 1710 may include or have access to a computing environment that includes input 1716, output 1718, and a communication connection 1720. The computer may operate in a networked environment using a communication connection 1720 to connect to one or more remote computers, remote sensors, detection devices, hand-held devices, multi-function devices (MFDs), mobile devices, tablet devices, mobile phones, Smartphones, or other such devices. The remote computer may also include a personal computer (PC), server, router, network PC, RFID enabled device, a peer device or other common network node, or the like. The communication connection may include a Local Area Network (LAN), a Wide Area Network (WAN), Bluetooth connection, or other networks. This functionality is described more fully in the description associated with FIG. 18 below.

Output 1718 is most commonly provided as a computer monitor, but may include any output device. Output 1718 and/or input 1716 may include a data collection apparatus associated with computer system 1700. In addition, input 1716, which commonly includes a computer keyboard and/or pointing device such as a computer mouse, computer track pad, or the like, allows a user to select and instruct computer system 1700. A user interface can be provided using output 1718 and input 1716. Output 1718 may function as a display for displaying data and information for a user, and for interactively displaying a graphical user interface (GUI) 1730.

Note that the term “GUI” generally refers to a type of environment that represents programs, files, options, and so forth by means of graphically displayed icons, menus, and dialog boxes on a computer monitor screen. A user can interact with the GUI to select and activate such options by directly touching the screen and/or pointing and clicking with a user input device 1716 such as, for example, a pointing device such as a mouse and/or with a keyboard. A particular item can function in the same manner to the user in all applications because the GUI provides standard software routines (e.g., module 1725) to handle these elements and report the user's actions. The GUI can further be used to display the electronic service image frames as discussed below.

Computer-readable instructions, for example, program module or node 1725, which can be representative of other modules or nodes described herein, are stored on a computer-readable medium and are executable by the processing unit 1702 of computer 1710. Program module or node 1725 may include a computer application. A hard drive, CD-ROM, RAM, Flash Memory, and a USB drive are just some examples of articles including a computer-readable medium.

FIG. 18 depicts a graphical representation of a network of data-processing systems 1800 in which aspects of the present invention may be implemented. Network data-processing system 1800 is a network of computers or other such devices such as mobile phones, smartphones, sensors, detection devices, controllers, and the like in which embodiments of the present invention may be implemented. Note that the system 1800 can be implemented in the context of a software module such as program module 1725. The system 1800 includes a network 1802 in communication with one or more clients 1810, 1812, and 1814. Network 1802 may also be in communication with one or more device 1804, servers 1806, and storage 1808. Network 1802 is a medium that can be used to provide communications links between various devices and computers connected together within a networked data processing system such as computer system 1700. Network 1802 may include connections such as wired communication links, wireless communication links of various types, fiber optic cables, quantum, or quantum encryption, or quantum teleportation networks, etc. Network 1802 can communicate with one or more servers 1806, one or more external devices such as a controller, actuator, sensor, or other such device 1804, and a memory storage unit such as, for example, memory or database 1808. It should be understood that device 1804 may be embodied as a detector device, microcontroller, controller, receiver, transceiver, or other such device.

In the depicted example, device 1804, server 1806, and clients 1810, 1812, and 1814 connect to network 1802 along with storage unit 1808. Clients 1810, 1812, and 1814 may be, for example, personal computers or network computers, handheld devices, mobile devices, tablet devices, smartphones, personal digital assistants, microcontrollers, recording devices, MFDs, etc. Computer system 1700 depicted in FIG. 17 can be, for example, a client such as client 1810 and/or 1812.

Computer system 1700 can also be implemented as a server such as server 1806, depending upon design considerations. In the depicted example, server 1806 provides data such as boot files, operating system images, applications, and application updates to clients 1810, 1812, and/or 1814. Clients 1810, 1812, and 1814 and external device 1804 are clients to server 1806 in this example. Network data-processing system 1800 may include additional servers, clients, and other devices not shown. Specifically, clients may connect to any member of a network of servers, which provide equivalent content.

In the depicted example, network data-processing system 1800 is the Internet with network 1802 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data and messages. Of course, network data-processing system 1800 may also be implemented as a number of different types of networks such as, for example, an intranet, a local area network (LAN), or a wide area network (WAN). FIGS. 17 and 18 are intended as examples and not as architectural limitations for different embodiments of the present invention.

FIG. 19 illustrates a software system 1900, which may be employed for directing the operation of the data-processing systems such as computer system 1700 depicted in FIG. 17. Software application 1905, may be stored in memory 1704, on removable storage 1712, or on non-removable storage 1714 shown in FIG. 17, and generally includes and/or is associated with a kernel or operating system 1910 and a shell or interface 1915. One or more application programs, such as module(s) or node(s) 1725, may be “loaded” (i.e., transferred from removable storage 1714 into the memory 1704) for execution by the data-processing system 1700. The data-processing system 1700 can receive user commands and data through user interface 1915, which can include input 1716 and output 1718, accessible by a user 1920. These inputs may then be acted upon by the computer system 1700 in accordance with instructions from operating system 1910 and/or software application 1905 and any software module(s) 1725 thereof.

Generally, program modules (e.g., module 1725) can include, but are not limited to, routines, subroutines, software applications, programs, objects, components, data structures, etc., that perform particular tasks or implement particular abstract data types and instructions. Moreover, those skilled in the art will appreciate that elements of the disclosed methods and systems may be practiced with other computer system configurations such as, for example, hand-held devices, mobile phones, smart phones, tablet devices, multi-processor systems, printers, copiers, fax machines, multi-function devices, data networks, microprocessor-based or programmable consumer electronics, networked personal computers, minicomputers, mainframe computers, servers, medical equipment, medical devices, and the like.

Note that the term module or node as utilized herein may refer to a collection of routines and data structures that perform a particular task or implements a particular abstract data type. Modules may be composed of two parts: an interface, which lists the constants, data types, variables, and routines that can be accessed by other modules or routines; and an implementation, which is typically private (accessible only to that module), and which includes source code that actually implements the routines in the module. The term module may also simply refer to an application such as a computer program designed to assist in the performance of a specific task such as word processing, accounting, inventory management, etc., or a hardware component designed to equivalently assist in the performance of a task.

The interface 1915 (e.g., a graphical user interface 1730) can serve to display results, whereupon a user 1920 may supply additional inputs or terminate a particular session. In some embodiments, operating system 1910 and GUI 1730 can be implemented in the context of a “windows” system. It can be appreciated, of course, that other types of systems are possible. For example, rather than a traditional “windows” system, other operation systems such as, for example, a real time operating system (RTOS) more commonly employed in wireless systems may also be employed with respect to operating system 1910 and interface 1915. The software application 1905 can include, for example, module(s) 1725, which can include instructions for carrying out steps or logical operations such as those shown and described herein.

The following description is presented with respect to embodiments of the present invention, which can be embodied in the context of, or require the use of, a data-processing system such as computer system 1700, in conjunction with program module 1725, and data-processing system 1800 and network 1802 depicted in FIGS. 17-3. The present invention, however, is not limited to any particular application or any particular environment. Instead, those skilled in the art will find that the systems and methods of the present invention may be advantageously applied to a variety of system and application software including database management systems, word processors, and the like. Moreover, the present invention may be embodied on a variety of different platforms including Windows, Macintosh, UNIX, LINUX, Android, Arduino and the like. Therefore, the descriptions of the exemplary embodiments, which follow, are for purposes of illustration and not considered a limitation.

U.S. Pat. No. 10,070,509, titled “COMPACT SRF BASED ACCELERATOR,” issued on Sep. 4, 2018, describes a particle accelerator comprising an accelerator cavity, an electron gun, and a cavity cooler configured to at least partially encircle the accelerator cavity. A cooling connector and an intermediate conduction layer are formed between the cavity cooler and the accelerator cavity to facilitate thermal conductivity between the cavity cooler and the accelerator cavity. The embodiments disclosed therein teach a viable, compact, robust, high-power, high-energy electron-beam, or x-ray source. The disclosed advances are integrated into a single design, that enables compact, mobile, high-power electron accelerators. U.S. Pat. No. 10,070,509 is herein incorporated by reference in its entirety.

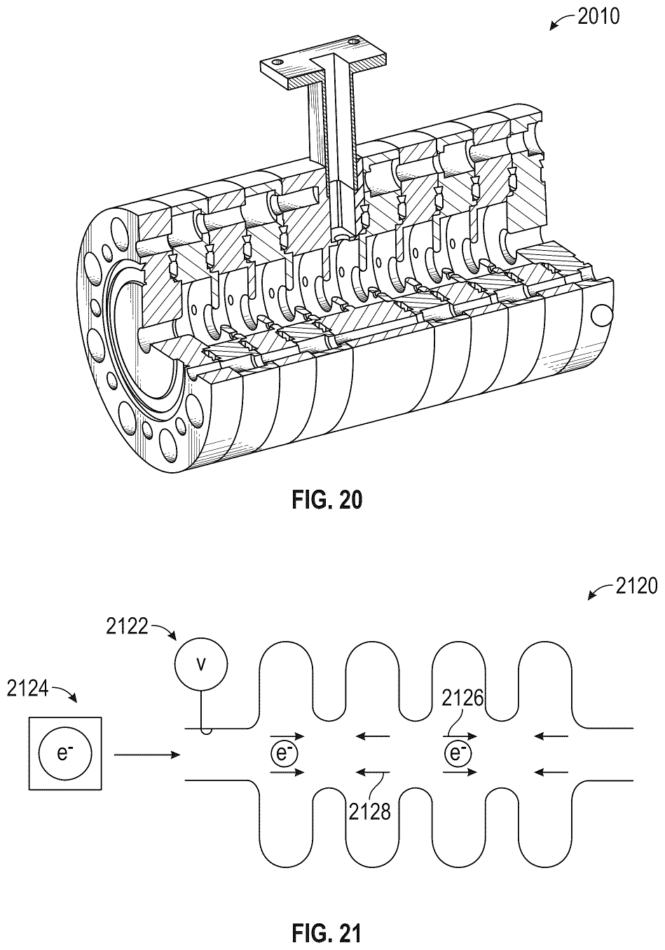

FIG. 20 illustrates a perspective cut-away view of an RF structure 2010 that can form elements of an electron accelerator that can be adapted for use in accordance with embodiments disclosed herein. Note that RF accelerator and electron gun structures can be employed to produce electron beams of the required energy for implementation of the disclosed embodiments. An electron accelerator, for example, that employs the RF structure 2010 can accelerate electrons generated from an electron gun with RF electric fields in resonant cavities sequenced such that the electrons are accelerated due to an electric field present in each cavity as the electron traverses the cavity to reach a beam extraction device.

FIG. 21 illustrates a perspective cut-away view of a four cell elliptical superconducting RF structure 2120 that can also form elements of an electron accelerator adapted for use in accordance with an embodiment. Note that varying embodiments can employ alternative cavity geometries and/or cell numbers. FIG. 21 generally indicates the operating principles of an elliptical RF cavity. Advancements in SRF technology can enable even more compact and efficient accelerators for this application.

The RF structure 2120 of FIG. 21 demonstrates the principle of operation in which alternating RF electric fields can be arranged to accelerate groups of electrons timed to arrive in each cavity when the electric field in that cavity causes the electrons to gain additional energy. In the particular embodiment shown in FIG. 21, a voltage generator 2122 can induce an electric field within the RF cavity. Its voltage can oscillate, for example, with a radio frequency of 1.3 Gigahertz or 1.3 billion times per second. An electron source 2124 can inject particles into the cavity in phase with the variable voltage provided by the voltage generator 2122 of the RF structure 2120. Arrow(s) 2126 shown in FIG. 21 indicate that the electron injection and cavity RF phase is adjusted such that electrons experience or “feel” an average force that accelerates them in the forward direction, while arrow(s) 2128 indicate that electrons are not present in a cavity cell when the force is in the backwards direction.

It can be appreciated that the example RF structures 2010 and 2120, respectively shown in FIGS. 20-21, represent examples only and that electron accelerators of other types and configurations/structures/frequencies may be implemented in accordance with alternative embodiments. That is, the disclosed embodiments are not limited structurally to the example electron accelerator structures 2010, 2120, respectively shown in FIGS. 20-5, but represent merely one possible type of structure that may be employed with particular embodiments. Alternative embodiments may vary in structure, arrangement, frequency, and type of utilized accelerators, RF structures, and so forth.

Based on the foregoing, it can be appreciated that a number of embodiments, preferred and alternative, are disclosed herein. In an embodiment, a fluid treatment method comprises inputting an input flow of water with a concentration of PFAS in the water, exposing the flow of water to an electron beam thereby generating aqueous electrons, destroying some of the concentration of PFAS in the water, and outputting an output flow of water with a PFAS concentration lower than the input flow of water. In an embodiment, the fluid treatment method further comprises filtering the input flow of water with a filter in order to generate a clean fluid stream, and an effluent stream of water with a higher concentration of PFAS than the input flow of water, wherein exposing the flow of water comprises exposing the effluent stream of water to the electron beam. In an embodiment, the filtering comprises at least one of reverse osmosis, foam fractionation, ion exchange, granular activated carbon, and crystallization.

In an embodiment, the fluid treatment method further comprises gas purging the input flow of water with a concentration of PFAS in the water. In an embodiment, the gas purging is done with nitrogen. In an embodiment, the gas purging is done with an inert gas.

In an embodiment, the fluid treatment method further comprises increasing the pH of the input flow of water with a concentration of PFAS in the water. In an embodiment, the PH of the input flow of water is increased to a pH of 11-14. In an embodiment, increasing the pH of the input flow of water with a plurality of PFAS in the water comprises adding NaOH to the input flow of water with a concentration of PFAS. In an embodiment, the fluid treatment method further comprises decreasing the pH of the output the flow of water after exposing the water to the electron beam.

In an embodiment, the fluid treatment method comprises transferring heat from the water output after exposing the water to the electron beam, to the input flow of water with a concentration of PFAS, with a heat exchanger. In an embodiment, the fluid treatment method further comprises filtering the output flow of water with a PFAS concentration lower than the input flow of water, with an output filter.

In an embodiment, a fluid treatment method comprises inputting an input flow of water with a concentration of PFAS in the water, filtering the input flow of water to increase the concentration of PFAS in the water, purging the input flow of water with a concentration of PFAS in the water, increasing the pH of the input flow of water with a concentration of PFAS in the water, heating the input flow of water with a concentration of PFAS in the water, exposing the input flow of water to an electron beam thereby generating aqueous electrons to destroy at least some of the of PFAS in the water, and outputting an output flow of water with a PFAS concentration lower than the input flow of water. In an embodiment, the filtering comprises at least one of reverse osmosis, foam fractionation, ion exchange, granular activated carbon, and crystallization. In an embodiment, the fluid treatment method further comprises the gas purging is done with one of nitrogen or an inert gas. In an embodiment, heating the input flow of water with a concentration of PFAS in the water further comprises transferring heat from the output flow of water to the input flow of water with a concentration of PFAS, with a heat exchanger. In an embodiment, the fluid treatment method further comprises decreasing the pH of the output the flow of water after exposing the water to the electron beam.

In an embodiment, a fluid treatment system comprises an input for inputting an input flow of water with a concentration of PFAS in the water, a particle accelerator configured to generate an electron beam, a fluid channel configured to expose the input flow of water to the electron beam, thereby generating aqueous electrons which destroy some of the concentration of PFAS in the water, and an output for outputting an output flow of water with a PFAS concentration lower than the input flow of water. In an embodiment, the system further comprises at least one of a filter for filtering the input flow of water, and a gas purging tank for gap purging the input flow of water with a concentration of PFAS in the water. In an embodiment, the fluid treatment system further comprises a heat exchanger for transferring heat from the output flow of water to the input flow of water with a concentration of PFAS.

It should be appreciated that variations of the above-disclosed and other features and functions, or alternatives thereof, may be desirably combined into many other different systems or applications. It should be understood that various presently unforeseen or unanticipated alternatives, modifications, variations, or improvements therein may be subsequently made by those skilled in the art which are also intended to be encompassed by the following claims.

What is claimed is:

1. A fluid treatment method comprising:
inputting an input flow of water with a concentration of PFAS in the water;
exposing the flow of water to an electron beam thereby generating aqueous electrons;
destroying some of the concentration of PFAS in the water; and
outputting an output flow of water with a PFAS concentration lower than the input flow of water.

2. The fluid treatment method of claim 1 further comprising:
filtering the input flow of water with a filter in order to generate a clean fluid stream, and an effluent stream of water with a higher concentration of PFAS than the input flow of water, wherein exposing the flow of water comprises exposing the effluent stream of water to the electron beam.

3. The fluid treatment method of claim 2 wherein the filtering comprises at least one of:
reverse osmosis;
foam fractionation;
ion exchange;
granular activated carbon; and
crystallization.

4. The fluid treatment method of claim 1 further comprising:
gas purging the input flow of water with a concentration of PFAS in the water.

5. The fluid treatment method of claim 4 wherein the gas purging is done with nitrogen.

6. The fluid treatment method of claim 4 wherein the gas purging is done with an inert gas.

7. The fluid treatment method of claim 1 further comprising:
increasing the pH of the input flow of water with a concentration of PFAS in the water.

8. The fluid treatment method of claim 7 wherein the PH of the input flow of water is increased to a pH of 11-14.

9. The fluid treatment method of claim 7 wherein increasing the pH of the input flow of water with a plurality of PFAS in the water comprises:
adding NaOH to the input flow of water with a concentration of PFAS.

10. The fluid treatment method of claim 1 further comprising:
decreasing the pH of the output the flow of water after exposing the water to the electron beam.

11. The fluid treatment method of claim 1 further comprising:
transferring heat from the water output after exposing the water to the electron beam, to the input flow of water with a concentration of PFAS, with a heat exchanger.

12. The fluid treatment method of claim 1 further comprising:
filtering the output flow of water with a PFAS concentration lower than the input flow of water, with an output filter.

13. A fluid treatment method comprising:
inputting an input flow of water with a concentration of PFAS in the water;
filtering the input flow of water to increase the concentration of PFAS in the water;
purging the input flow of water with a concentration of PFAS in the water;
increasing the pH of the input flow of water with a concentration of PFAS in the water;
heating the input flow of water with a concentration of PFAS in the water;
exposing the input flow of water to an electron beam thereby generating aqueous electrons to destroy at least some of the of PFAS in the water; and
outputting an output flow of water with a PFAS concentration lower than the input flow of water.

14. The fluid treatment method of claim 13 wherein the filtering comprises at least one of:
reverse osmosis;
foam fractionation;
ion exchange;
granular activated carbon; and
crystallization.

15. The fluid treatment method of claim 13 wherein the gas purging is done with one of:
nitrogen; or
an inert gas.

16. The fluid treatment method of claim 13 wherein heating the input flow of water with a concentration of PFAS in the water further comprises:
transferring heat from the output flow of water to the input flow of water with a concentration of PFAS, with a heat exchanger.

17. The fluid treatment method of claim 13 further comprising:
decreasing the pH of the output the flow of water after exposing the water to the electron beam.

18. A fluid treatment system comprising:
an input for inputting an input flow of water with a concentration of PFAS in the water;
a particle accelerator configured to generate an electron beam;
a fluid channel configured to expose the input flow of water to the electron beam, thereby generating aqueous electrons which destroy some of the concentration of PFAS in the water; and
an output for outputting an output flow of water with a PFAS concentration lower than the input flow of water.

19. The fluid treatment system of claim 18 further comprising at least one of
a filter for filtering the input flow of water; and
a gas purging tank for gap purging the input flow of water with a concentration of PFAS in the water.

20. The fluid treatment system of claim 18 further comprising:
a heat exchanger for transferring heat from the output flow of water to the input flow of water with a concentration of PFAS.
